(19) United States
(12) Patent Application Publication
(10) Pub. No.: US 2003/0211782 A1
(43) Pub. Date: Nov. 13, 2003

(54) Filtered RJ11 connector module with LED indicators and method of manufacturing

(75) Inventors: Lawrence Yu Esparaz, Carmona (PH); Danny Alvaro Villaron, Carmona (PH); Joseph Lorenzo De Guzman, North Hills, CA (US)

Correspondence Address: JOSEPH DE GUZMAN, 16799 SCHOENBORN STREET, NORTH HILLS, CA, 91343, US

(73) Assignee: Mr. Joseph Lorenzo De Guzman, North Hills, CA (US)

(21) Appl. No.: 10/063,636

(22) Filed: May 7, 2002

(51) Int. Cl. H01R 13/66

(52) U.S. Cl. 439/620

(57) ABSTRACT

A filtered RJ11 connector module that is adaptable for mounting on Home Phone Networking Alliance (HPNA) network interface card useful for home networking applications and other communication protocols involves the integration of filter module into the connector module itself. The filter module comprises an isolation transformer, common mode choke, filter components, high voltage capacitor and surge protection device that may be configured to customize any network interface card. Mounting of at least two light indicators on a printed circuit board is another embodiment of the invention and therefore, also an integral part of a filtered RJ11 connector module. The housing consists of at least one plug-receiving opening for receiving connector plugs that are electrically connected to a transmission medium. Each plug-receiving opening embodies a plurality of second member, upper contact leads that is an integral part of a plurality of first member, upper contact leads that is coupled with a filter module and plurality of second member, lower contact leads that is an integral part of a plurality of first member, lower contact leads that facilitate the mounting of a filtered RJ11 connector module on a network interface card. Still another embodiment of the invention is that a metal jacket may be configured to cover the housing. There is a minimal electrical distance between a plurality of second member, upper contact leads, filter module and first member, lower contact leads for improved signal performance. A method of manufacturing a filtered RJ11 connector module is also disclosed.

### BACKGROUND OF INVENTION

The present invention pertains to an electrical connector module that incorporate as an integral part thereof, the passive magnetic components inside the connector body (hereinafter, housing); particularly Registered Jack 11 (hereinafter, RJ11) connector module having passive magnetic components for filtering, isolation and protection purposes; and more particularly RJ11 connector module having filtering, isolation, protection and visual indicating means that is adaptable for mounting on Home Phone Networking Alliance (HPNA) network interface card useful for home networking applications and other communications protocols.

RJ11 connector is used vastly as input/output (I/O) interface for networking computers and other telephone system devices. The use of RJ11 connector is widely popular and existing in homes than the RJ45 connector that is interfaced with Unshielded Twisted Pair (UTP) or other transmission cable for Local Area Network (LAN) applications or other signal transmission and communication protocols. In our invention, RJ11 connector is used to interface with a telephone line wire for data transfer at an increasingly faster transmission rate. A silicon-based Integrated Circuit (IC) driver located on a printed circuit board (hereinafter, network interface card) sends signal path towards the filter module, surge protection device and then out of the connector module onto the telephone line wire as the transmission medium. The light indicators such as Light Emitting Diode (LED) or similar emit light that indicates an operational function.

A filter module may contain isolation transformer, filter components such as chip inductor and chip capacitor or similar, common mode choke (CMC), high voltage capacitor and surge protection device. The isolation transformer separates the two systems electrically (i.e., primary and secondary sides) and realizes the transformation of voltage or current then suppresses the influence of common mode disturbances. The filter components limit the transmission passband frequency. The common mode choke filters out noise and extraneous signals that may be present on or induced in the signals that pass through the connector module and suppresses extraneous Electromagnetic Interference (EMI) from being coupled into the signal lines that pass through the conductors. The high voltage capacitor is for grounding purposes and has also the features of filtering, noise suppression and surge protection. The surge protection device protects sensitive components that are connected to the data and transmission lines from over voltage caused by Electrostatic Discharge (ESD), Electrical Fast Transients (EFT) and lightning discharge pertaining to committee standards.

A filter module and a surge protection device are traditionally placed on a network interface card near the connector module. It is also known in the art that a pair of light indicators is employed in conjunction with the RJ11 connector module to provide a visual indication that data is being transmitted through a conductor such as telephone cables. These prior art consumes valuable board space making the board size bigger and restricted to a number of components. Due to a number of individual components mounted on a network interface card near the connector module, it is also possible in the known state of the art the introduction of unnecessary complexity to the design and therefore, performance degradation. The current flowing through the conductors that drive the light indicators is a source of electrical noise that is coupled into the signal lines passing through the connector module. Often, the filter module is designed per its specifications, commonly a molded package mounted on a network interface card near the connector module. Therefore, there is little consideration on the effects of the network interface card's conductors, surge protection device, light indicators, the leads of RJ11 connector module and leads of RJ11 connector plug when the filter module was designed. Hence, it is evident that what is needed is an electrical connector module which includes, as an integral part thereof, a filter module and light indicators.

### SUMMARY OF INVENTION

The objective of the present invention is to provide an improved and simplified filtered connector module that meets or exceeds the requirements of the modern home networking applications and other communications protocols. The other objective of the present invention is to address the concerns observed in the prior art as mentioned in the background of invention. The present invention satisfies the needs by providing an RJ11 connector module that incorporates a filter module with high voltage capacitor and light indicators within the connector module itself. In one embodiment of the invention, a filter module may be configured with or without the high voltage capacitor. In another embodiment of the invention, the said filter module may be configured with or without a surge protection device.

Consequently, the present invention conserves valuable board space and generally without affecting the footprint (i.e., the area required to mount the connector module on a network interface card) furthermore, may be less than the footprint of the prior art. Improved signal performance is achievable in this present invention due to the minimal electrical distance between the filter module and network interface card's conductor surfaces. The filter module is designed in vertical position within the housing adjacent, or as close as possible, to the surface of the network interface card on which the filtered dual connector module is mounted, thereby, minimizing the distance between the filter module and associated conductive traces of the network interface card. Minimizing the electrical distance results to prevention of acquiring signal interference and unwanted noise at sufficiently high frequencies, hence, avoiding unwanted coupling of high frequency noise and EMI entering the RJ11 connector plug and therefore, onto the conductors such as telephone cables. Such minimal electrical distance provided by the invention positively eliminates many of the problems associated with prior art connector modules wherein filter module are separately packaged and mounted near the connector module.

The filtered RJ11 connector module is compatible with the commonly available standard RJ11 plugs and even more, easy to install on a network interface card. Another important advantage of the invention is the reduction of manufacturing methods and labor in a network interface card manufacture thereby, decreasing the cost in general. This invention also discloses the method of fabricating such an improved and simplified filtered RJ11 connector module.

The first aspect of the invention constitutes the following elements; a connector module having two (or multiple) plug-receiving openings at the front surface of the housing for receiving RJ11 connector plugs and consisting of two view ports that constitute two light guides attached to two light sources are located at the lower central portion of a vertical partition wall in between the dual plug-receiving openings; a rear cover at the rear surface of the housing that covers the printed circuit board assembly of the filter module. The rear cover with slot guide and snap-like appendage features is fastened horizontally adjacent to the lower insert leads and top surface of the housing and that a metal shield may be configured to cover the filtered dual connector module; a plurality of first and second member upper contact leads and a plurality of first and second member lower contact leads; a plurality of second member, upper contact leads is disposed for easy engagement with an inserted RJ11 connector plug and is an integral part of a plurality of first member, upper contact leads that is electrically connected towards the filter module that is also electrically connected onto a plurality of second member, lower contact leads that is an integral part of first member, lower contact leads. A plurality of first member, lower contact leads is embedded and protruded in a base element at the bottom part of the housing to facilitate the mounting of a filtered dual connector module on a network interface card.

The second aspect of the invention comprises a method of manufacturing the filtered dual module connector.

a filter module is pre-assembled (hereinafter, PCBA) such that chip capacitors, chip inductors, wound ferrite cores, high voltage capacitor and light indicators are mounted on a printed circuit board. The PCBA may be configured with or without the high voltage capacitor and or with or without surge protection device. The light indicators such as LED though mounted on the printed circuit board are not electrically connected to the filter module hence avoid the possibility that light indicators themselves act as a noise source; placing a plurality of second member, lower contact leads electrically connected to a lower member, printed circuit board's thru-holes of the PCBA using high temperature soldering techniques; placing a first member, upper contact leads electrically connected to a plurality of upper member, printed circuit board's grooves using high temperature soldering techniques; applying epoxy on wound ferrite cores; inserting the semi-finished connector assembly into the housing; inserting and snapping the rear cover into the finished connector assembly and; inserting and snapping a metal shield into the filtered dual connector module may be configured in the method of manufacturing.

Embodiments of the invention will now be disclosed by way of example with reference to the accompanying drawings.

### BRIEF DESCRIPTION OF DRAWINGS

FIG. 1 is an exploded perspective view of a filtered dual RJ11 connector module.

FIG. 2 is a perspective view showing the portion of front, bottom and right side surface of a filtered dual RJ11 connector module.

FIG. 3 is a perspective view showing the portion of top, rear and left side surface of a filtered dual RJ11 connector module.

FIG. 4 is a front view of a filtered dual RJ11 connector module.

FIG. 4A is a front view that is an alternative to FIG. 4, a metal jacket inclusion.

FIG. 4B is a right side view that is an alternative to FIG. 4, a metal jacket inclusion.

FIG. 5 is a cross-sectional view showing the placement of light guides from cross-cut section of FIG. 9.

FIG. 6 is a perspective view of a front PCBA and lower insert leads pre-assembly.

FIG. 7 is an opposite perspective view of FIG. 6.

FIG. 7A is a perspective view that is an alternative to FIG. 6.

FIG. 7B is a perspective view that is another alternative to FIG. 6.

FIG. 7C is a perspective view that is still another alternative to FIG. 6.

FIG. 8 is a perspective view of a semi-finished connector assembly.

FIG. 9 is a cross-sectional view of a final connector assembly.

FIG. 10 is a perspective view showing a filtered dual connector module system.

FIG. 11 is an electrical schematic diagram of a filter module.

FIG. 12 is a process flow describing a logical method of manufacturing a filtered dual RJ11 connector module.

### DETAILED DESCRIPTION

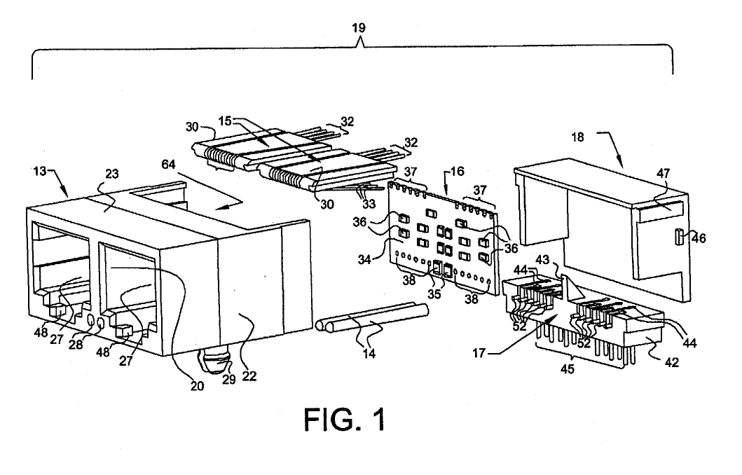

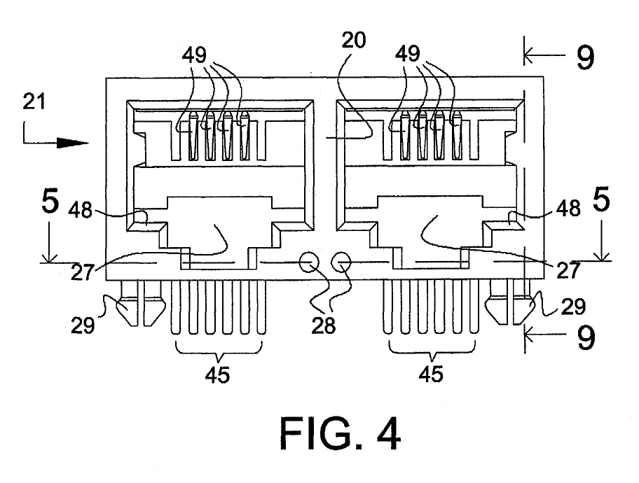

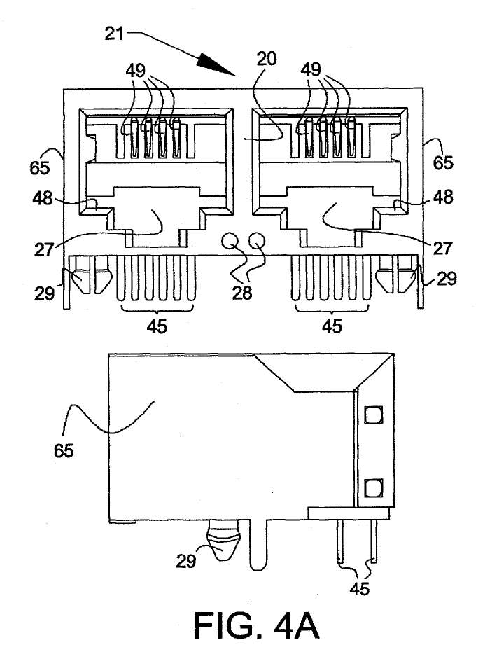

Referring to FIG. 1, an exploded view is shown to categorize the basic elements of one type of connector module made in accordance with this invention which can be called a filtered dual RJ11 connector module 19 consisting mainly of housing 13, light guides 14, upper insert leads 15, filter module 16, lower insert leads 17 and rear cover 18. A metal shield 65 may be configured with the housing as shown in FIG. 4A and FIG. 4B. Each of the basic elements will be further described in details hereinafter.

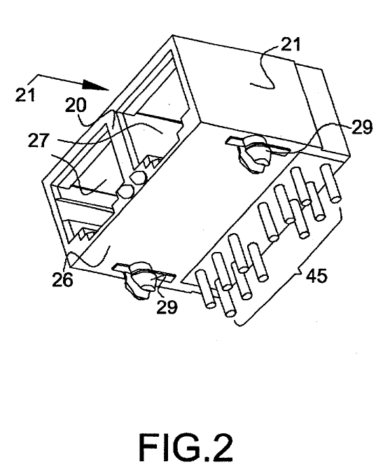

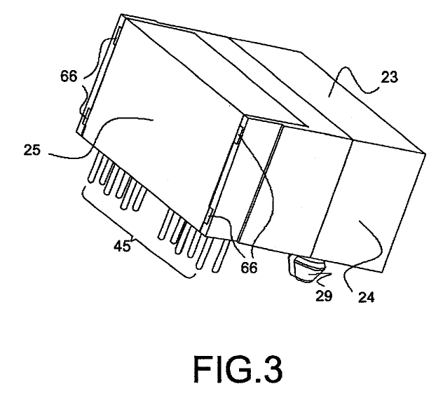

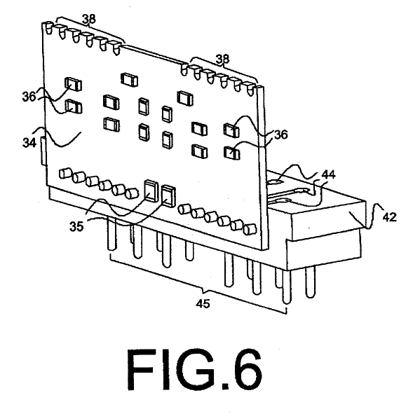

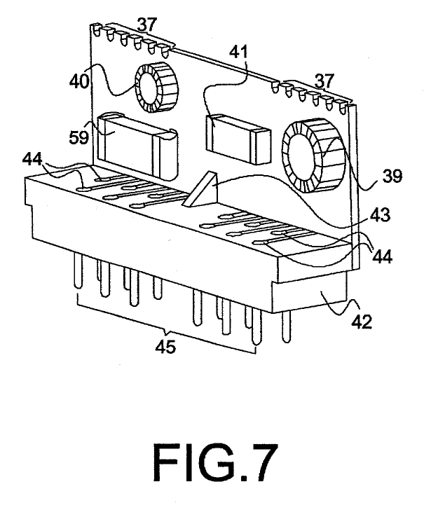

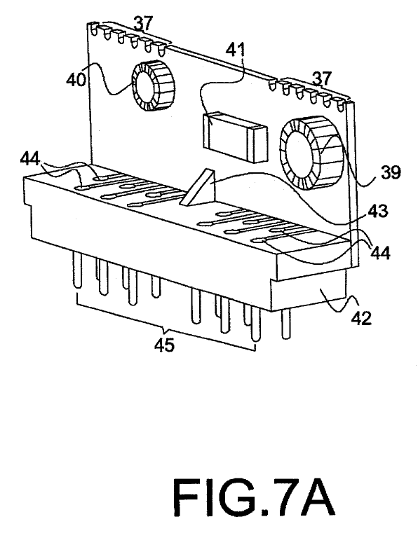

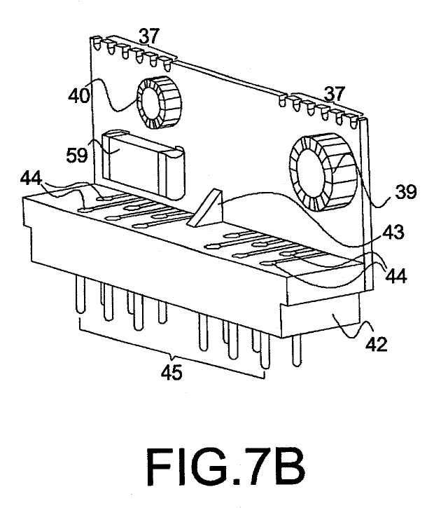

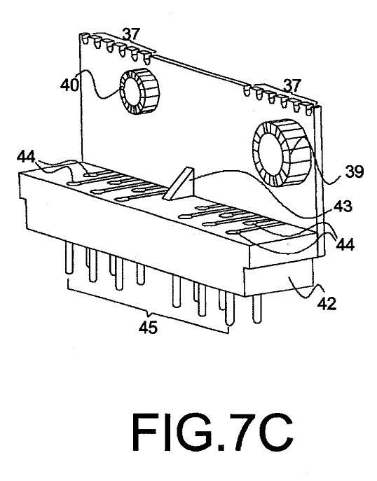

The housing 13 referring to FIGS. 1-4 embodies a front surface 21, right side surface 22, top surface 23, left side surface 24, rear surface 25 and bottom surface 26 all shown in various drawing sides. Pertaining to FIG. 1, at the housing's front surface 21 are two plug-receiving openings 27 each positioned horizontally adjacent and separated by a vertical wall partition 20. Still at the front surface 21 of the housing 13 are two view ports 28 located at central bottom of the vertical wall partition 20 in between the plug-receiving openings 27. Two board locks 29 that are best illustrated in FIG. 2 are situated at the bottom surface 26 of the housing 13. Two light guides 14 referring to FIG. 1 are to be embedded inside the view ports' 28 passage or cavity. Another basic element of the filtered dual RJ11 connector module 19 referring still to FIG. 1 and is, a part or element of the housing 13, is the upper insert leads 15 that involves an upper insert base 30, upper insert lead slots 31, first member upper contact leads 32 and second member upper contact leads 33. One embodiment of the present invention shown in FIG. 1 is a filter module 16 within the connector module 19 itself. Referring to FIGS. 6 and 7, a filter module 16 constitutes the following: 1. printed circuit board 34; 2. two Light Emitting Diode (LED) indicators 35; 3. chip inductors and chip capacitors 36; 4. Isolation transformer 39; 5. Common-mode choke 40 and; 6. high voltage capacitor 41. FIGS. 6 and 7 show the front and rear filter printed circuit board assembly (PCBA) 62, 63. FIG. 7A is another rear PCBA configuration that does not involve high voltage capacitor 41. FIG. 7B is still another rear PCBA configuration that involves high voltage capacitor 41 and surge protection device 59. FIG. 7C is yet still another rear PCBA configuration that only involves a surge protection device 59. Next basic element of the present invention and still, another part or element of the housing 13 is a lower insert leads 17. Similar to that of the upper insert leads 15, lower insert leads 17 as illustrated in FIG. 1 involves a lower insert base 42 with PCB stopper 43, lower contact lead slots 44, first member lower contact leads 45 and second member lower contact leads 52. Finally, the filtered dual connector module 19 includes a rear cover 18 with a snap-like appendage 46 referring to FIG. 1 and is yet another, an integral part of the housing 13 as shown in FIG. 3.

The following paragraph denotes the functionality of each terminology as far as the field of invention is concerned.

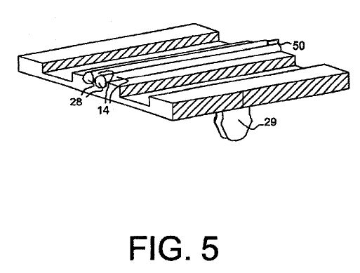

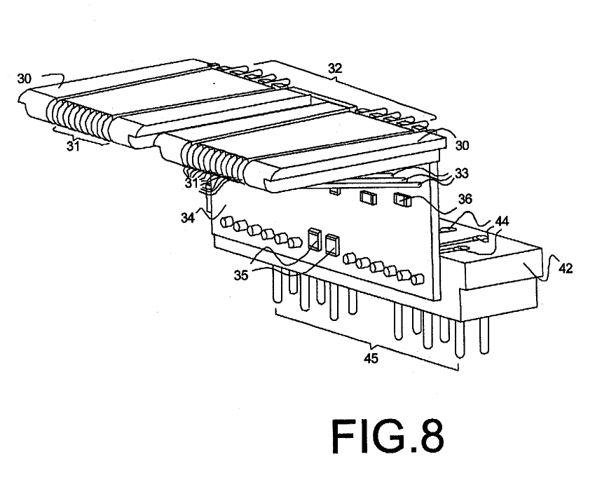

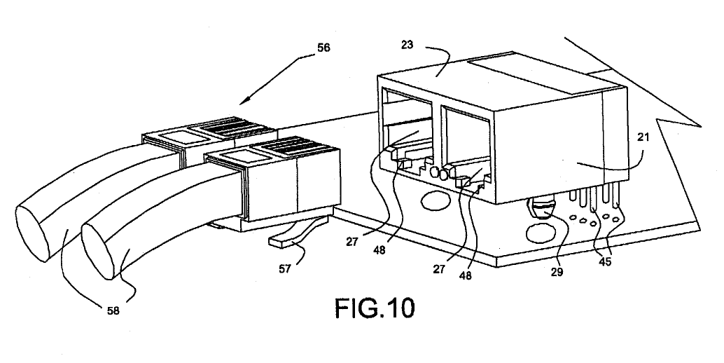

Referring to FIGS. 1-4 showing the various aspects of a filter dual RJ11 connector module 19 evidently characterizes that the invention can be adaptable for mounting on a network interface card 55 as shown in FIG. 10. The connector involves housing 13 with two plug-receiving openings 27 for receiving RJ11 connector plugs. Still referring to FIG. 10, each plug-receiving opening 27 integrates with a plurality of first and second member, upper contact leads 32, 33 situated inside the housing to form an electrical connection with the corresponding leads of the RJ11 connector plugs 56 and towards the individual telephone line wires 58. A plurality of first member, lower contact leads 45 and board locks 29 that protrude at the housing's bottom surface 26 facilitate the mounting of a filtered dual RJ11 connector module 19 onto a network interface card 55. Referring to FIGS. 8 and 10, a standard RJ11 connector plugs 56 that couple with the assembled filter module 16 are electrically connected through a plurality of first and second member, upper contact leads 32, 33 and a plurality of first and second member, lower contact leads 45, 52, as close as possible to the cable wire 58 connection. This configuration offers the optimum possible signal performance. The integration of light indicators 35 within the dual connector module 19 is another embodiment of the present invention. Light guides 14 are employed, as needed, to carry light emitted from the light indicators such as LEDs 35 towards the corresponding view ports 28 located at the central bottom of the vertical wall partition 20 in between the plug-receiving openings 27. Light indicators 35 operate to indicate 1) reception or transmission of data or signals; 2) verification of a good connection between separate equipment or; 3) a defect in a network transmission or any other state or condition in the equipment with which the connector is operatively associated. FIGS. 5 and 6 illustrates light indicators and light guides assembly.

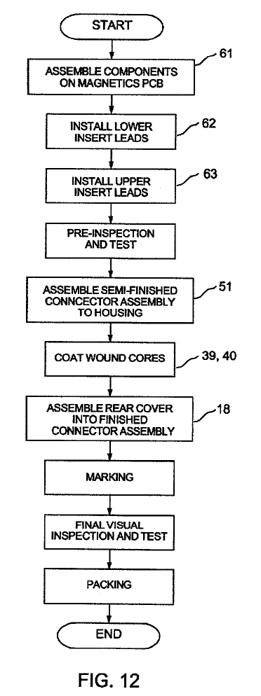

The integration of light indicators 35 and filter module 16 and method of manufacturing a filtered dual connector module 19 are described in the next paragraphs. FIG. 1 represents the major assembly of the invention but FIGS. 5, 6, 7, 8 and 9 are necessary to describe in detail the significant processing steps of the invention. FIG. 12 is a process flow chart of the present invention.

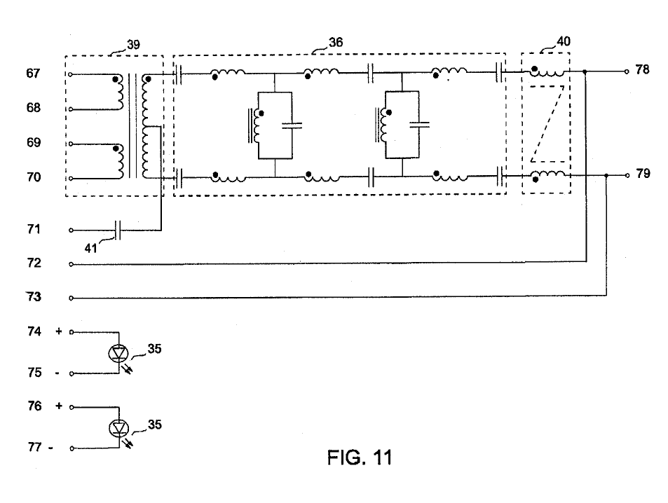

FIG. 5 refers to the inclusion of light guides 74 where the oval ends enter a horizontal passage inherent in the bottom center of the housing 13 beginning from the rear surface 25 heading the front surface 21 such that the oval ends protrudes a little, enough to create view ports 28. In between the inherent passages at the rear surface 25 of the housing 13 is a separator 50 that formed part just in the middle of the housing 13. The separator 50 prevents the light emitted by one light indicator 35 then carried by one light guide 14 interfering with the light emitted by the other light indicator 35 then carried by the other light guide 14. Referring to FIG. 6, the light indicators 35 are mounted vertically at the bottom center of a printed circuit board 34 distant from the filter components 36. The light indicators such as LEDs 35 are mounted on a printed circuit board 34 through leads 74, 75, 76 and 77 in such a circuit connection that is in accordance with the electrical schematic diagram shown in FIG. 11, thus enable for them to emit light when current driven. Returning to FIG. 1, the other ends of the light guides 14 at the rear surface 25 of the housing 13 and an integral part of the view ports 28 at the front surface 21 are horizontally aligned to the light indicators 35 mounted on printed circuit board 34.

The filter components such as chip inductors and chip capacitors are 36 mounted on a printed circuit board 34 as shown in FIG. 6 in such a circuit connection that is in accordance with the electrical schematic diagram shown in FIG. 11. Referring now to FIGS. 6, 7 and 11, the filter components 36 are electrically connected with an isolation transformer 39 and common mode choke 40 that are mounted opposite the filter components 36 via thru-holes and circuit traces of the printed circuit board 34. The high voltage capacitor 41 directing towards the ground of a network interface card 55 through lead 71 as shown in FIG. 11 is electrically connected with an isolation transformer (i.e. center tap of secondary side). The filter components 36 for filtering purposes are mounted on the front side of printed circuit board 34 vertically adjacent but on the opposite side of the lower insert base 42. FIG. 7 shows the assembly of an isolation transformer 39, common mode choke 40 and high voltage capacitor 41 that are soldered opposite the light indicators 35 and filter components″ 36 placement on printed circuit board 34. Therefore, light indicators 35, filter components 36, isolation transformer 39, common mode choke 40 and high voltage capacitor 41 are pre-assembled on a printed circuit board 34 through soldering techniques wherein the components assembly will be called PCBA 61 hereinafter. The electrical connection of these components on a printed circuit board 34 in accordance with the electrical schematic diagram shown in FIG. 11 generally provides an improved electrical connector module.

FIGS. 6 and 7 show respectively the connection or attachment of a front and rear PCBA 62, 63 to a plurality of first member, lower contact leads 45. Referring to FIG. 6, the second member, lower contact leads 52 are 90° bent leads that are to be inserted towards the lower member, printed circuit board's thru-holes 38 (not shown) for establishing an electrical connection between the first member, lower contact leads 45 and PCBA 61. The PCBA 61 still referring to FIG. 6 is vertically adjoined with the lower insert leads 17 by the process of insertion as described, then by soldering techniques. Hence, the rear and front PCBA 62, 63 shown in FIGS. 6 and 7 establish an electrical connection in accordance with the electrical schematic diagram shown in FIG. 11 via circuit traces connected from the soldered components of the filter module 16 and the first member, lower contact leads 45. Therefore, an electrical connection is now established between filter module 16 and network interface card 55 (not shown in FIGS. 6 and 7) through the PCBA 61 that is adjoined with a plurality of first and second member, lower contact leads 45, 52. FIG. 7 emphasizes the opposite view of the rear PCBA 63 called front PCBA 62 and lower insert leads 17 attachment as the result of insertion and soldering processes described above. On top and center of the lower insert base 42 is a PCBA stopper 43 for solder joints reliability even with the presence of mechanical stresses and fatigues that might have brought by environmental shocks and processing steps. FIGS. 7A, 7B and 7C show alternative PCBA 61 as mentioned in the second paragraph above.

FIG. 8 is the next process to complete the electrical connection required per the electrical schematic diagram in FIG. 11. A plurality of first member, upper contact leads 32 that are slightly embedded in slots 31 on top of an upper insert base 30 extend in an appropriate length that is adaptable for insertion and soldering toward a plurality of upper member, printed circuit board's grooves 37 such that the upper insert leads 15 is perpendicular to the PCBA 61. A plurality of second member, upper contact leads 33 are formed 40° below the horizontal upper insert base 30 wherein said leads 33 permit a spring action to provide contact pressure and retention with the leads of a RJ11 connector plug 56 (not shown in FIG. 8). Referring to FIG. 11, the input of an isolation transformer (i.e. primary side) are electrically connected to first member, lower contact leads 45 designated as 67, 68, 69 and 70. On the other hand, the output of an isolation transformer (i.e. secondary side) heading towards the other components of the circuit are electrically connected to second member, upper contact leads 33 designated as 78 and 79. The electrical schematic diagram in FIG. 11 may be configured to include a surge protection device through leads 72 and 73. Returning to FIG. 8, the input terminal wires of an isolation transformer 39 that are soldered opposite the filter components 36 are electrically connected to a plurality of first and second member, lower contact leads 45, 52. On the other hand, the output terminal wires of an isolation transformer 39 that are soldered opposite the filter components 36 are electrically connected to a plurality of first and second member, upper contact leads 32, 33. As mentioned in the previous paragraph, an electrical connection is established between the filter module 16 and network interface card 55 (not shown in FIG. 8) through a plurality of first and second member, lower contact leads 45, 52 electrically connected with the PCBA 61. Now, a complete electrical connection is established beginning from a network interface card 55 through a plurality of first and second member, lower contact leads 45, 52 then towards the PCBA 61 then onto the RJ11 connector plug 56 through a plurality of first and second member upper contact leads 32, 33 and vice versa. FIG. 10 illustrates a filtered dual RJ11 connector system.

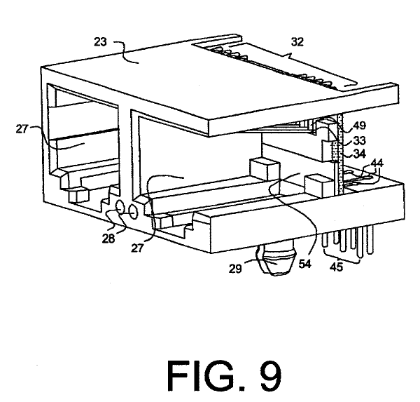

A semi-finished connector assembly 51 in FIG. 8 at its front side is inserted and fastened into a rear opening 64 of the housing 13 resulting to a finished connector assembly 53. FIG. 9 illustrates the inclusion of the housing 13, the process next semi-finished connector assembly. A cross-sectional view at FIG. 9 is shown to emphasize the placement of a plurality of second member, upper contact leads 33 in the vertical fingers 49 of the housing's horizontal partition 54 to guide, separate and insulate said leads. The second member, upper contact leads 33 are the contact points to the leads of RJ11 connector plugs 56 (not shown) once inserted in the plug receiving openings 27 located at the front surface 21 of the housing 13. Prior the housing insertion process, the soldered isolation transformer 39 and common mode choke 40 on the rear PCBA 63 illustrated in FIG. 7 are coated with an epoxy for protection purposes.

The final process of the invention that is partly illustrated in FIG. 1 is the snapping of a rear cover 18 into a rear opening 64 through a rear opening slots 66 of the finished connector assembly. A rear cover has on both side surfaces, a slot guide 47 to lead the insertion process and snap-like appendage 46 to fasten the rear cover and finished connector assembly 53. FIGS. 2, 3 and 4 are now the presentation of the final filtered dual connector module. FIGS. 4A and 4B represent another embodiment of the present invention with an inclusion of metal jacket.

The filtered dual RJ11 connector module 19 is functional when the first member, lower contact leads 45 are mounted on a network interface card 55 such as shown in FIG. 10. The contact portions referring still in FIG. 10 are mainly the first member, lower contact leads 45 and second member, upper contact leads 52 (not shown). Both the RJ11 connector plugs 56 and plug-receiving openings 27 have equally matched stepped grooves 48 to fit the plugs 56 correspondingly. Pressing the plug's tab 57 along with the stepped grooves 48 facilitates the insertion then the plug likewise locks with the existence of the tab's 57 snap-like appendage feature when the plug is fully inserted. In this way, an electrical connection is established between the plurality of the second member, upper contact leads 33 (not shown) and the leads 60 of the RJ11 connector plugs 56 wherein corresponding telephone line wires 58 are electrically connected to said leads of the RJ11 connector plugs. An electrical connection is thereby established to the filter module 16 through a plurality of a second member, upper contact leads 33 (not shown) to the telephone line wires 58 through a plurality of RJ11 connector plug's 56 leads 60. Furthermore, the filtered dual RJ11 connector module 19 being the present invention that have been described by means of specific embodiments and applications thereof, provides a versatile 2-wire transmission network interface on a LAN particularly on a home phone networking applications.

Despite the fact that the present invention was described in reference to a specific embodiment, the disclosure set forth in the aforementioned paragraphs is illustrative only and does not delimit the invention to further aspects, embodiments and configurations not fully disclosed herein but within the principles and scope of the invention, as defined by the appended claims.

We claim:

1. A filtered RJ11 connector module, comprising;
a housing with at least one plug-receiving opening adaptable for receiving at least one electrical connector plug that may be configured to adapt home networking and LAN Ethernet system functions; at least two view ports that constitute light guides that are coupled with light sources; plurality of first and second member, lower contact leads and; plurality of first and second member, upper contact leads and;
a filter module inside the housing that form the isolation, filtering and protection circuitry consisting mainly of printed circuit board, filter components or similar, isolation transformer, common mode choke, surge protection device and high voltage suppression device that may be configured to customize any network interface card.

2. The filtered RJ11 connector module of claim 1, wherein said plug-receiving openings opposed top and bottom surfaces joined by opposed right and left side surfaces extending from front surface to rear surface of the housing.

3. The filtered RJ11 connector module of claim 1, wherein said home networking system function and other communications protocols involve the integration of filter module into a connector module embodied by single or multiple RJ11 plug-receiving opening for receiving single or multiple RJ11 connector plug.

4. The filtered RJ11 connector module of claim 1, wherein said LAN Ethernet system function and other communications protocols involve the integration of filter module into a connector module embodied by dual or multiple RJ11 and single RJ45 plug-receiving openings for receiving dual or multiple RJ11 and single RJ45 connector plugs.

5. The filtered RJ11 connector module of claim 1, wherein said view ports' placement may be configured to adapt a single RJ11 connector module, multiple RJ11 connector module and multiple RJ11 with single RJ45 connector module.

6. The filtered RJ11 connector module of claim 1, wherein said light guides that constitute the view ports are installed in a housing cavity or passage.

7. The filtered RJ11 connector module of claim 1, wherein said light sources are light emitting diode (LED) indicators or similar and are now an integral part thereof, the connector module.

8. The filtered RJ11 connector module of claim 1, wherein said plurality of first member, lower contact leads are an integral part of the second member, lower contact leads that are formed L-shaped, mounted in a lower insert base with the first and second member vertically and horizontally adjacent with said lower insert base, respectively and that the form of upper insert leads may be configured to provide a surface mount filtered RJ11 connector module.

9. The filtered RJ11 connector module of claim 8, wherein said plurality of second member, lower contact leads is connected to the filter module that are inserted and soldered through to the plurality of lower member, printed circuit boards thru-holes of the PCBA regardless of position except that minimal electrical distance is maintained between filter module and network interface card.

10. The filtered RJ11 connector module of claim 1, wherein said plurality of first member, upper contact leads are an integral part of the second member, upper contact leads that are formed such that the first member is horizontally embedded in an upper insert base and the second member is formed 40° below the horizontal upper insert base.

11. The filtered RJ11 connector module of claim 10, wherein each of the second member, upper contact leads is assembled in the vertical fingers inside the plug-receiving openings of the housing.

12. The filtered RJ11 connector module of claim 10, wherein said plurality of first member, upper contact leads are inserted and soldered to the upper member printed circuit board's grooves of the PCBA regardless of position except that minimal electrical distance is maintained between filter module and network interface card.

13. The filtered RJ11 connector module of claim 1, wherein said filter components are chip inductors and chip capacitors; wherein the high voltage capacitor is at least 1000 picofarad, 2 kV capacitor and; wherein the surge protection device has a voltage rating of at least 90 Volts.

14. The filtered RJ11 connector module of claim 1, wherein said isolation transformer and common mode choke are wound ferrite cores or similar.

15. The filtered RJ11 connector module of claim 1, wherein said filter module is now an integral part of a connector module.

16. The filtered RJ11 connector module of claim 1, wherein said filter module may be configured with or without the high voltage capacitor and; with or without the surge protection device.

17. The filtered RJ11 connector module's electrical system includes;
a light source such as LED to indicate reception or transmission of data or signals; verification of a good connection between separate equipment or; a defect in a network transmission or any other state or condition in the equipment with which the connector is operatively associated;
a filter circuit that sets a specific passband frequency that allows only signals within the passband to pass through unattenuated;
a high voltage component such as capacitor for avoiding ground-loop effects and with features of (Electromagnetic Interference) EMI suppression;
an isolation transformer and a common mode choke for signal isolation and protection and filtering of noise and EMI, respectively and;
a surge protection device that protects sensitive components that are connected to the data and transmission lines from overvoltage caused by Electrostatic Discharge (ESD), Electrical Fast Transients (EFT) and lightning discharges.

18. The filtered RJ11 connector module's electrical system of claim 17, wherein said light sources that pair with light guides are actually, at least two light indicators such as LED mounted on a printed circuit board.

19. The filtered RJ11 connector module's electrical system of claim 17, wherein said filter circuit per the electrical schematic diagram shown in FIG. 11 is transformed into PCBA, particularly front PCBA and wherein said filter circuit may be configured to customize any network interface card.

20. The filtered RJ11 connector module's electrical system of claim 19, wherein said front PCBA is vertically attached to the plurality of first member, upper contact leads to minimize electrical distance between the filter module, plurality of second member, upper contact leads and a connector plug and therefore, improving the signal performance.

21. The filtered RJ11 connector module's electrical system of claim 20, wherein said plurality of second member upper contact leads provides contact pressure and retention with the leads of a connector plug when such plug is inserted.

22. The filtered RJ11 connector module's electrical system of claim 17, wherein said isolation transformer and common mode per the electrical schematic diagram shown in FIG. 11 is transformed into PCBA, particularly rear PCBA and may be configured to customize any network interface card.

23. The filtered RJ11 connector module's electrical system of claim 22, wherein said rear PCBA is vertically attached to the plurality of second member, lower contact leads to minimize electrical distance between the filter module and first member, lower contact leads and thus, improving the signal performance.

24. The filtered RJ11 connector module's electrical system of claim 23, wherein said plurality of first member, lower contact leads are adaptable for mounting onto a network interface card.

25. The filtered RJ11 connector module's electrical system of claim 17, wherein said light indicators and filter module are now an integral part thereof, the connector module.

26. The filtered RJ11 connector module's electrical system of claim 17, wherein said filter module is electrically connected to the plurality of first member, lower contact leads and the plurality of second member, upper contact leads that likewise connects to a network interface card and a connector plug, respectively.

27. The filtered RJ11 connector module's electrical system of claim 17, wherein said filter components, isolation transformer, common mode choke, high voltage capacitor and surge protection device constitute one embodiment of a filter module and other embodiments include: with or without the high voltage capacitor; with or without surge protection device adaptable for any network interface card.

28. The filtered RJ11 connector module's electrical system of claim 27, wherein said filter components, isolation transformer, common mode choke, high voltage capacitor and surge protection device may be configured in such an electrical schematic diagram adaptable for any network interface card.

29. A method of manufacturing a filtered RJ11 connector module consists of;
pre-assembly or mounting of said filter components, isolation transformer, common mode choke, high voltage capacitor and surge protection device on printed circuit board through soldering techniques;
insertion and soldering of the plurality of second member, lower contact leads into the plurality of lower member, printed circuit thru-hole of the PCBA;
insertion and soldering of the plurality of the first member, upper contact leads into the plurality of upper member, printed circuit grooves of the PCBA;
coating of wound ferrite cores;
insertion and snapping of the semi-finished connector assembly into the housing and;
insertion and snapping of a rear cover into the finished connector assembly.

30. A method of manufacturing a filtered RJ11 connector module of claim 29, wherein said pre-assembly or mounting of filter components, isolation transformer, common mode choke, high voltage capacitor and surge protection device may be configured to adapt any network interface card.

31. A method of manufacturing a filtered RJ11 connector module of claim 29, wherein a metal jacket to the housing may be configured with the said connector module.
